(19) United States
(12) Patent Application Publication
(10) Pub. No.: US 2025/0200526 A1
(43) Pub. Date: Jun. 19, 2025

(54) SYSTEM AND METHOD FOR PREDICTING ROAD DETERIORATION

(71) Applicant: GM Global Technology Operations LLC, Detroit, MI (US)

(72) Inventors: Matthew Edward Gilbert-Eyres, Rochester Hills, MI (US); Craig Thomas Douglas, Pflugerville, TX (US); Alec M. Wuorinen, Columbus, OH (US); Donald K. Grimm, Utica, MI (US)

(73) Assignee: GM Global Technology Operations LLC, Detroit, MI (US)

(21) Appl. No.: 18/541,325

(22) Filed: Dec. 15, 2023

(51) Int. Cl. G06Q 10/20; G07C 5/00; G07C 5/08

(52) U.S. Cl. CPC G06Q 10/20; G07C 5/008; G07C 5/0808

(57) ABSTRACT

A system for predicting road deterioration includes memory hardware in communication with data processing hardware. The memory hardware storing instructions that when executed on the data processing hardware cause the data processing hardware to perform operations including collecting sensor data from a plurality of vehicles traveling over a road, determining a road maintenance score (RMS) for the road based on the collected sensor data, and determining a trend line for the road, the trend line being indicative of future maintenance requirements of the road based on the RMS.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method for predicting road deterioration.

Infrastructure relates to the fixed installations required for a country to properly function. For example, infrastructure includes roads, bridges, dams, water and sewer systems, railways, subways, airports, and harbors to name a few. Of these types of infrastructure, roads and bridges play a vital role in the everyday lives of virtually every person in every country by enabling people to travel for work, recreation, and pleasure. Further, such roads and bridges are imperative to commerce by providing arteries for the delivery of goods and services.

While roads and bridges play an important role in society, roads and bridges are often in disrepair due to lack of proper maintenance, changing weather conditions, overuse, and/or damage caused by use, vandalism, or acts of nature. Keeping up with maintaining roads and bridges is a difficult task given the sheer number of roadways and bridges in any given country. Further, such maintenance often comes at a steep cost. Namely, the actual money spent in performing road maintenance is often quite high. Further, closing or partially closing a roadway or bridge results in lost tolls, inefficiencies, and restrictions to commerce.

Maintaining roads and bridges is imperative but is often not performed in a timely fashion. While there are a variety of reasons for road municipalities delaying or otherwise not timely maintaining a road or bridge, the lack of maintenance of this vital infrastructure often comes down to cost and/or awareness. With respect to cost, maintaining or replacing a road or bridge is costly with the needs of such repair and replacement often exceeding the available budget of a road municipality to perform such maintenance and construction. Further, road municipalities are often unaware of a deteriorating road or bridge until the road or bridge requires extensive repair or replacement. In other words, road municipalities are often not able to perform minor maintenance that could prevent larger and more costly repairs because the road municipality is simply unaware of the required maintenance.

### SUMMARY

In one configuration, a system for predicting road deterioration is provided and includes memory hardware in communication with data processing hardware. The memory hardware storing instructions that when executed on the data processing hardware cause the data processing hardware to perform operations including collecting sensor data from a plurality of vehicles traveling over a road, determining a road maintenance score (RMS) for the road based on the collected sensor data, and determining a trend line for the road, the trend line being indicative of future maintenance requirements of the road based on the RMS.

The system may include one or more of the following optional features. For example, collecting sensor data from a plurality of vehicles may include collecting data from at least one vehicle sensor. The at least one vehicle sensor may include at least one of a camera, a suspension displacement sensor, an accelerometer, and a wheel rotation sensor.

An alert may be issued to a road management entity (RME) when the RMS exceeds a threshold value. In one configuration, tiered alerts may be issued to the RME based on a degree to which the RMS exceeds the threshold value. The RMS may be multiplied by a multiplier before comparing the RMS to the threshold value, the multiplier being based on a road type. The multiplier may be larger for roads experiencing traffic volumes that exceed a predetermined traffic threshold and may be smaller for roads experiencing traffic volumes that are below the predetermined traffic threshold.

The trend line may be updated based on sensor data received from vehicles traveling over the road. Additionally or alternatively, a feature map may be created that identifies features of the road based on the collected sensor data. Further, a vehicle navigation system may be updated with road conditions based on the collected sensor data.

In another configuration, a system for predicting road deterioration is provided and includes memory hardware in communication with data processing hardware. The memory hardware storing instructions that when executed on the data processing hardware cause the data processing hardware to perform operations including determining a road maintenance score (RMS) for roads based on collected sensor data from vehicles traveling on the roads, multiplying the RMS by a multiplier to create a multiplied RMS value, the multiplier being larger for roads experiencing traffic volumes that exceed a predetermined traffic threshold and smaller for roads experiencing traffic volumes that are below the predetermined traffic threshold, comparing the multiplied RMS value to a threshold RMS value, and alerting a road management entity (RME) to a potential future maintenance issue if the RMS exceeds the threshold RMS value.

The system may include one or more of the following optional features. For example, collecting sensor data from a plurality of vehicles may include collecting data from at least one vehicle sensor. The at least one vehicle sensor may include at least one of a camera, a suspension displacement sensor, an accelerometer, and a wheel rotation sensor.

In one configuration, alerting an RME to a potential future maintenance issue may include issuing tiered alerts to the RME based on a degree to which the RMS exceeds the threshold RMS value. Additionally or alternatively, a vehicle navigation system may be updated with road conditions based on the collected sensor data.

In another configuration, a system for predicting road deterioration is provided and includes memory hardware in communication with data processing hardware. The memory hardware storing instructions that when executed on the data processing hardware cause the data processing hardware to perform operations including collecting sensor data from a plurality of vehicles traveling over a road, the sensor data including at least one of image data, video data, suspension displacement data, and wheel rotation data, determining a road maintenance score (RMS) for the road based on the collected sensor data, comparing the RMS for the road to a threshold RMS value, and alerting a road management entity (RME) to a potential future maintenance issue if the RMS exceeds the threshold RMS value.

The system may include one or more of the following optional features. For example, the RMS may be multiplied by a multiplier to create a multiplied RMS value, the multiplier being larger for roads experiencing traffic volumes that exceed a predetermined traffic threshold and smaller for roads experiencing traffic volumes that are below the predetermined traffic threshold. Comparing the RMS to the threshold RMS value may include comparing the multiplied RMS value to the threshold RMS value.

Tiered alerts may be issued to the RME based on a degree to which the RMS exceeds the threshold RMS value. Additionally or alternatively, a vehicle navigation system may be updated with road conditions based on the collected sensor data.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle traveling on a roadway and in communication with a cloud-based computer;

FIG. 2 is a functional block diagram of a body control module (BCM) of the vehicle of FIG. 1 receiving sensor data and in communication with a cloud-based computer;

FIG. 3 is a functional block diagram of a system and method of predicting road degradation in accordance with the principles of the present disclosure; and

FIG. 4 is a flowchart detailing operation of the system and method of predicting road degradation of FIG. 3.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

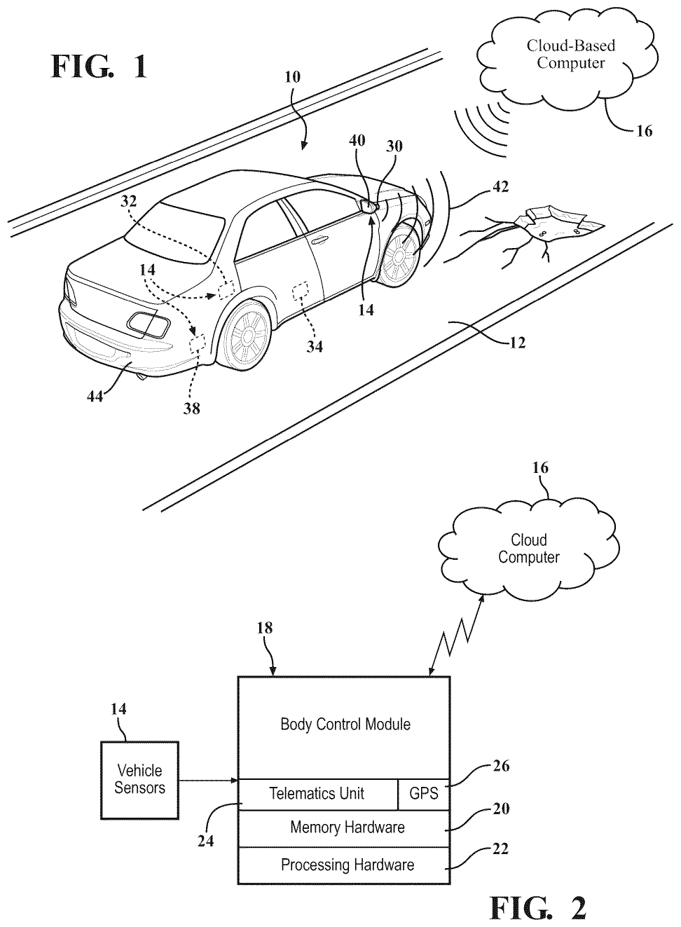

With particular reference to FIG. 1, a vehicle 10 is shown traveling on a road 12. The vehicle 10 includes a number of sensors 14 that may be used by the vehicle 10 in determining a condition of the road 12. The condition of the road 12 may be transmitted by the vehicle 10 to a cloud-based computer 16, for example, for use by the cloud-based computer 16 in predicting degradation of the road 12, creating a trend line for the particular road 12, and/or alerting a third party such as a road municipality of a road condition and/or a predicted future road condition. The data sensed by the vehicle 10 can be crowdsourced with data from other vehicles traveling on the road 12 for use by the cloud-based computer 16 in creating the trend line and/or predicting future degradation of the road 12, as will be described in greater detail below.

With particular reference to FIG. 2, the vehicle 10 is shown as including a body control module (BCM) 18. The BCM 18 includes memory hardware 20 and processing hardware 22 that cooperate to perform vehicle functions. In the context of the present application, the memory hardware 20 may store sensor data received from the one or more vehicle sensors 14 while the processing hardware 22 may process the sensor data and may use the sensor data to determine a condition of the road 12. The BCM 18 may additionally include a telematics unit 24 the provides for communication between the vehicle 10 and a cellular network to allow the BCM 18 to communicate with the cloud-based computer 16. As will be described, the BCM 18—via the telematics unit 24 and the cellular network—may transmit the sensor data received from the vehicle sensors 14 and/or an analysis of the road 12 as determined by the processing hardware 22 to the cloud-based computer 16 for use by the cloud-based computer 16 in predicting degradation of the road 12. Finally, the BCM 18 may include a Global Positioning System (GPS) 26 configured to determine a location of the vehicle 10. A position of the vehicle 10 may be determined by the on-board GPS 26 and may be transmitted to the cloud-based computer 16 via the vehicle telematics unit 24 and the cellular network.

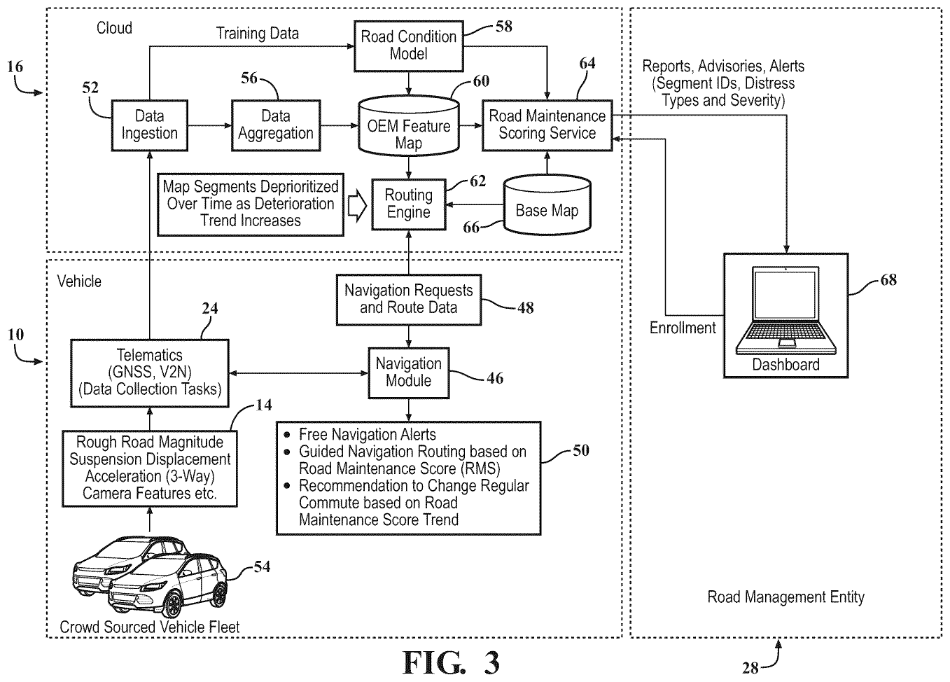

With particular reference to FIG. 3, a functional block diagram of a system and method of determining degradation of a road, such as the road 12 shown in FIG. 1, is provided. The system generally includes the vehicle 10 in communication with the cloud-based computer 16 and, further, shows the cloud-based computer 16 in communication with a road management entity (RME) 28. The RME 28 may be a municipality (i.e., a city or town) and/or may be a road commission responsible for maintaining the road 12.

The vehicle 10 includes the vehicle sensors 14 and the telematics unit 24, as previously described. The vehicle sensors 14 may include a camera 30 capturing images and/or video data of an area in and around the vehicle 10 during use, a suspension displacement sensor 32 configured to determine a displacement of a vehicle suspension (not shown), an accelerometer 34 configured to determine acceleration along the y and z planes of the vehicle 10 during operation, and a wheel rotation sensor 38 configured to detect an amount of rotation of each wheel 36 of the vehicle 10 such as, for example, a Hall effect sensor. While the vehicle sensors 14 are shown and described as including the foregoing sensors 30, 32, 34, and 38, the vehicle 10 could include any number of the sensors 30, 32, 34, and 38. For example, each wheel 36 may include a dedicated suspension displacement sensor 32 and wheel rotation sensor 38. Further, the vehicle 10 may include a number of cameras 30 located at various locations such as, for example, on side-view mirrors 40, in a front fascia 42, and/or in a rear fascia 44 (FIG. 1).

The vehicle telematics unit 24 may communicate with a cellular network via a Global Navigation Satellite System (GNSS) and/or via a Vehicle-to-Network (V2N) communication system. Communication between the vehicle telematics unit 24 and the cellular network allows the BCM 18 to communicate sensor data received from the various vehicle sensors 14 to the cloud-based computer 16.

In addition to the vehicle sensors 14 and the vehicle telematics unit 24, the vehicle 10 also includes a navigation module 46 that receives navigation requests and route data 48 from the cloud-based computer 16 and provides navigation alerts, guided navigation routing based on a road maintenance score (RMS), and recommends changes to a regular route or commute based on a trend of the RMS at 50.

With continued reference to FIG. 3, the vehicle telematics unit 24 transmits sensor data from the vehicle sensors 14 to the cloud-based computer 16 at 52. The received sensor data is described as coming from the example vehicle 10 shown in FIG. 1 but also includes crowdsourced data from other vehicles traveling on the same road 12. The crowdsourced data is taken over time for numerous vehicles, which are schematically represented in FIG. 3 at 54. The sensor data from the vehicles is transmitted by individual vehicle telematics units associated with each vehicle to the cloud-based computer 16 at 52. The sensor data received by the cloud-based computer 16 is aggregated at 56 and is forwarded to a road condition model (RCM) at 58 for analysis, as will be described in more detail below. The RCM 58 transmits the analyzed data to a feature map at 60, which identifies features of the road 12 such as, for example, road treatments (i.e., salt, sand, etc.) that may affect road wear, low spots in the road 12 that may pool water, and cracks in the road 12 among other features. This information is then sent to a routing engine 62, which will provide information to the navigation module 46 of the vehicle 10 to alert the vehicle occupants to potential hazards in the road (i.e., low spots, cracks, etc.). The information provided to the navigation module 46 may be used by the navigation module 46 to warn vehicle occupants via a graphical user interface (GUI) within a cabin of the vehicle 10 and, further, may cause the navigation module 46 to recommend a different route in an effort to avoid rough road conditions that could damage the vehicle 10 and/or provide an uncomfortable ride. In the case of an autonomous or semi-autonomous vehicle, the navigation module 46 may automatically change the route of the vehicle 10 if the information received from the routing engine 62 of the cloud-based computer 16 indicates that the current route of the vehicle 10 could cause damage to the vehicle 10 or cause a rough or dangerous ride for the vehicle occupants.

The results from the RCM 58 and the features of the road 12 (from 60) are transmitted to a road maintenance scoring service (RMSS) 64. The RMSS 64 utilizes the data from the RCM 58 and the features of the road 12 along with map data 66 to determine a maintenance score for the particular road 12. Further, if numerous vehicles traveling on the road 12 transmit data to the cloud-based computer 16 at 52, the RMSS 64 can determine a road score, which can provide an indication as to the current state of a particular road, maintenance that should be scheduled, and/or repairs that need to be made as soon as possible. The information from the RMSS 64 may be transmitted to one or more road management entities (RME) 28 and, more specifically, to a database 68 for use by the RME 28 in scheduling, budgeting, and forecasting road maintenance needs.

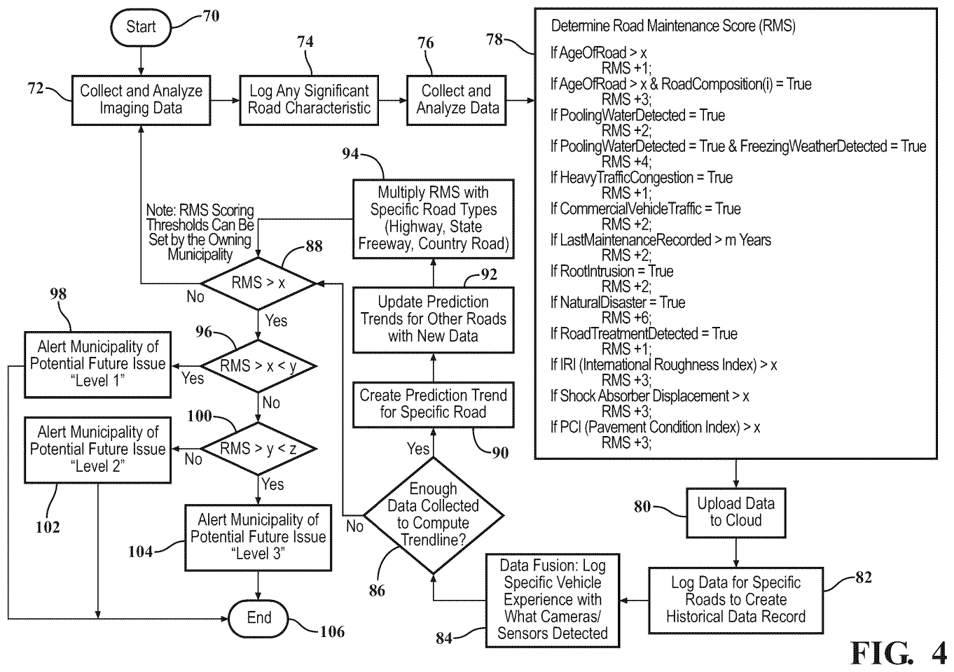

With particular reference to FIG. 4, a system and method for predicting road deterioration in accordance with the present disclosure is provided. The system and method starts at 70) and collets data from the various vehicle sensors 14 at 72. The data is analyzed at 72 and significant road characteristics are logged at 74. For example, if a camera 30 detects pooling water on the road 12, a crack or pothole in the road 12 (FIG. 1), and/or root intrusion in the road 12 caused by nearby vegetation, the memory hardware 20 of the BCM 18 stores the data and the processing hardware 22 analyzes the date to determine the feature of the road (i.e., a low spot, crack, pothole, etc.). While the processing hardware 22 is described as analyzing the sensor data from the vehicle sensors 14, this function could be additionally or alternatively performed by the cloud-based computer 16. Finally, when analyzing the data, the processing hardware 22 links the detected road condition or feature to the geographical location of the vehicle 10 based on information from the GPS 26. This way, the location of the road condition or feature is known and can be used by the cloud-based computer 16 in scoring the road 12.

The data from the vehicle sensors 14 and the analysis performed by the processing hardware 22 in terms of determining what the sensor data indicates about the road 12 (i.e., if the sensor data indicates a low spot, pooled water, a crack, etc.) is collected and transmitted to the cloud-based computer 16 at 76 via the vehicle telematics unit 24. The cloud-based computer 16 will determine a road maintenance score (RMS) for the road 12 based on the data from the vehicle 10. While the current example is described with respect to the single vehicle 10, the cloud-based computer 16 receives data from numerous vehicles traveling over the same road 12 as the vehicle 10 over time. This data will be used by the cloud-based computer 16 in determining, validating, and updating the RMS for the road 12.

When determining the RMS, the cloud-based computer 16 scores the various conditions received from the vehicle 10 at 78. For example, the cloud-based computer 16 will add values to a running RMS based on the data received for a particular roadway 12. As shown in FIG. 4, the cloud-based computer 16 will add one (1) point to the RMS if the age of the road 12 is greater than X, where X is a predetermined number of years programmed into the cloud-based computer 16. The cloud-based computer 16 will also add one point to the RMS if the sensor data indicates high traffic levels on the road 12 or if road treatments are detected or reported (i.e., salt and/or sand applied to the road 12). The cloud-based computer 16 may add two (2) points to the RMS if pooling water is detected on the road 12, if commercial vehicle traffic is detected (i.e., heavy, generally large vehicles), if the last maintenance performed on the road 12 is greater than M years, where M is a predetermined number of years programmed into the cloud-based computer 16, or if root intrusion is detected.

The cloud-based computer 16 will add three (3) points to the RMS if the age of the road 12 is greater than X years, where X is a predetermined number of years programmed into the cloud-based computer 16, if the International Roughness Index (IRI) is greater than X, where X is a predetermined value of IRI programmed into the cloud-based computer 16, if the shock absorber displacement is greater than X, where X is a predetermined displacement programmed into the cloud-based computer 16, or if the Pavement Condition Index (PCI) is greater than X, where X is a predetermined value of PCI programmed into the cloud-based computer 16.

The cloud-based computer 16 will add four (4) points to the RMS if pooling water is detected along with freezing weather conditions. Finally, the cloud-based computer 16 will add six (6) points to the RMS if a natural disaster in the area of the road 12 is detected or reported.

While the foregoing point values are disclosed, different point values could be applied to the various road conditions. Further, the cloud-based computer 16 can alter the foregoing point values over time when analyzing the performance of the system and method shown in FIG. 4. For example, if the cloud-based computer 16 determines that the RMS is not representative of the actual road conditions, the cloud-based computer 16 can increase or decrease one or more of the foregoing point values until the resulting RMS is representative of the actual road conditions. The point values may be adjusted after comparing the RMS determined by the cloud-based computer 16 to the actual, observed road conditions.

The RMS may be saved in the cloud-based computer 16, uploaded to a separate cloud-based computer at 82, and/or sent to a database for use by an RME 28 in determining a road condition and/or determining what roads need maintenance and when such maintenance should be performed. While the RMS may be stored by the cloud-based computer 16, transmitted to a different cloud-based computer, or sent to a database for use by an RME 28, the RMS will be described hereinafter as being used by the cloud-based computer 16 in determining when a particular road will require maintenance.

The RMS may be logged and stored for specific roads by the cloud-based computer 16 at 82 to create a historical database. The historical database may be used by the cloud-based computer 16 to track road conditions and/or by an RME 28 to track the condition of roadways under its jurisdiction. As described, as vehicles travel over the road 12, sensor data detected by the vehicle sensors 14 is transmitted to the cloud-based computer 16 for use in determining the RMS. The sensor data from the vehicles received by the cloud-based computer 16 may be fused with the stored features of the road 12 to determine if the current vehicle experience (i.e., the current sensor data) is aligned with the historical data for the road 12 stored in the cloud-based computer 16 at 84.

The cloud-based computer 16 will determine if there is sufficient data from vehicles traveling on the road 12 to compute a trend line at 86. If not, the cloud-based computer 16 will determine if the RMS is greater than a threshold value of X at 88. If the RMS is not greater than X at 88, the cloud-based computer 16 returns to 72 to continue collecting data.

If there is sufficient data for the cloud-based computer 16 to compute a trend line at 86, the cloud-based computer 16 will create a prediction trend line for the particular road 12 at 90. The prediction trend line is based on sensor data received from numerous vehicles traveling over the particular road 12 and can be used by the cloud-based computer 16 and/or an RME 28 in determining the deterioration of the road 12. For example, if the sensor data indicates the presence of a crack in the road 12 along with shock absorber displacement of Y, and sensor data later indicates a larger crack or pothole along with shock absorber displacement greater than Y, the cloud-based computer 16 will determine that the condition of the road 12 is deteriorating and that maintenance might soon be required. This continual monitoring and updating of logged sensor data allows the cloud-based computer 16 to update the prediction trends for the road 12 based on new data at 92. Further, the trend line may be applied to similar roads for use in predicting future maintenance needs. For example, a road having a similar construction as the road 12 (i.e., materials used, age of the road, etc.), experiencing similar traffic volume as the road 12, and being located in a similar geographical location may use the trend line generated for the road 12 to predict future maintenance.

The RMS determined by the cloud-based computer 16 may be used in conjunction with a multiplier at 94 based on the type of road and the traffic the road experiences. For example, a larger multiplier may be used in conjunction with the RMS for a highway as compared to a country road, as the highway experiences a larger traffic volume than the country road. As such, if a 2× multiplier is used for a highway and a 1× multiplier is used for a country road, the RMS score for the highway will tend to be larger than for a country road to ensure that the roads receiving the most traffic are properly maintained. The multiplier may be set by the cloud-based computer 16 or may be determined by the RME 28.

The adjusted RMS (i.e., once adjusted based on a multiplier) is compared to a the threshold X RMS at 88. If the RMS is less than X, the cloud-based computer 16 continues to collect data from vehicles traveling on the road 12 at 72. If the RMS is greater than X, the cloud-based computer 16 will determine whether the RMS is greater than X but less than Y at 96 where Y is a threshold RMS value that is greater than X. If the RMS is greater X but less than Y, the cloud-based computer 16 will alert the RME 28 at 98 to the possibility of a “Level 1” potential future road maintenance issue. For example, the Level 1 potential future road maintenance issue might relate to damage caused by a tree root. The current condition of the road might be such that the presence of the root is detected and that a future crack and/or larger bump in the road might occur, thereby requiring maintenance.

If the RMS is not less than Y at 96, the cloud-based computer 16 will determine whether the RMS is greater than Y but less than Z at 100 where Z is a threshold RMS value that is greater than Y. If the RMS is greater Y but less than Z, the cloud-based computer 16 will alert the RME 28 at 102 to the possibility of a “Level 2” potential future road maintenance issue. For example, the Level 2 potential future road maintenance issue might relate to damage caused by small pothole. The current condition of the road might be such that the presence of the pothole is detected and that a future larger pothole in the road might occur when subjected to pooling, frozen water, thereby requiring maintenance.

If the RMS is greater than Z at 100, the cloud-based computer 16 will alert the RME 28 at 104 to the possibility of a “Level 3” potential future road maintenance issue. For example, the Level 3 potential future road maintenance issue might relate to damage caused by a large pothole. The current condition of the road might be such that the presence of the large pothole is detected and that a future larger pothole in the road might occur when subjected to pooling, frozen water, thereby requiring maintenance. Following issuance of the alerts at 98, 102, and 104, the cloud-based computer 16 stops at 106.

As described, the system and method of the present disclosure may leverage vehicle sensor data and, further, may crowdsource such sensor data in an effort to generate trend lines for roads. The trend lines may be used to predict road deterioration in an effort to allow a RME 28 to perform smaller, less-expensive road repairs before the underlying issue causing the repair turns into a larger, more expensive road repair or replacement.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for predicting road deterioration, the system comprising:
memory hardware in communication with data processing hardware, the memory hardware storing instructions that when executed on the data processing hardware cause the data processing hardware to perform operations comprising:
collecting sensor data from a plurality of vehicles traveling over a road;
determining a road maintenance score (RMS) for the road based on the collected sensor data; and
determining a trend line for the road, the trend line being indicative of future maintenance requirements of the road based on the RMS.

2. The system of claim 1, wherein collecting sensor data from a plurality of vehicles includes collecting data from at least one vehicle sensor.

3. The system of claim 2, wherein the at least one vehicle sensor includes at least one of a camera, a suspension displacement sensor, an accelerometer, and a wheel rotation sensor.

4. The system of claim 1, further comprising issuing an alert to a road management entity (RME) when the RMS exceeds a threshold value.

5. The system of claim 4, further comprising issuing tiered alerts to the RME based on a degree to which the RMS exceeds the threshold value.

6. The system of claim 4, further comprising multiplying the RMS by a multiplier before comparing the RMS to the threshold value, the multiplier being based on a road type.

7. The system of claim 6, wherein the multiplier is larger for roads experiencing traffic volumes that exceed a predetermined traffic threshold and smaller for roads experiencing traffic volumes that are below the predetermined traffic threshold.

8. The system of claim 1, further comprising updating the trend line based on sensor data received from vehicles traveling over the road.

9. The system of claim 1, further comprising creating a feature map that identifies features of the road based on the collected sensor data.

10. The system of claim 1, further comprising updating a vehicle navigation system with road conditions based on the collected sensor data.

11. A system for predicting road deterioration, the system comprising:
memory hardware in communication with data processing hardware, the memory hardware storing instructions that when executed on the data processing hardware cause the data processing hardware to perform operations comprising:
determining a road maintenance score (RMS) for roads based on collected sensor data from vehicles traveling on the roads;
multiplying the RMS by a multiplier to create a multiplied RMS value, the multiplier being larger for roads experiencing traffic volumes that exceed a predetermined traffic threshold and smaller for roads experiencing traffic volumes that are below the predetermined traffic threshold;
comparing the multiplied RMS value to a threshold RMS value; and
alerting a road management entity (RME) to a potential future maintenance issue if the RMS exceeds the threshold RMS value.

12. The system of claim 11, wherein collecting sensor data from a plurality of vehicles includes collecting data from at least one vehicle sensor.

13. The system of claim 12, wherein the at least one vehicle sensor includes at least one of a camera, a suspension displacement sensor, an accelerometer, and a wheel rotation sensor.

14. The system of claim 11, wherein alerting an RME to a potential future maintenance issue includes issuing tiered alerts to the RME based on a degree to which the RMS exceeds the threshold RMS value.

15. The system of claim 11, further comprising updating a vehicle navigation system with road conditions based on the collected sensor data.

16. A system for predicting road deterioration, the system comprising:
memory hardware in communication with data processing hardware, the memory hardware storing instructions that when executed on the data processing hardware cause the data processing hardware to perform operations comprising:
collecting sensor data from a plurality of vehicles traveling over a road, the sensor data including at least one of image data, video data, suspension displacement data, and wheel rotation data;
determining a road maintenance score (RMS) for the road based on the collected sensor data;
comparing the RMS for the road to a threshold RMS value; and
alerting a road management entity (RME) to a potential future maintenance issue if the RMS exceeds the threshold RMS value.

17. The system of claim 16, further comprising multiplying the RMS by a multiplier to create a multiplied RMS value, the multiplier being larger for roads experiencing traffic volumes that exceed a predetermined traffic threshold and smaller for roads experiencing traffic volumes that are below the predetermined traffic threshold.

18. The system of claim 17, wherein comparing the RMS to the threshold RMS value includes comparing the multiplied RMS value to the threshold RMS value.

19. The system of claim 16, further comprising issuing tiered alerts to the RME based on a degree to which the RMS exceeds the threshold RMS value.

20. The system of claim 16, further comprising updating a vehicle navigation system with road conditions based on the collected sensor data.
